(19) United States
(12) Patent Application Publication
(10) Pub. No.: US 2009/0174087 A1
(43) Pub. Date: Jul. 9, 2009

(54) One piece liquid injection spray cylinder/nozzle

(76) Inventor: Charles Gustav Bauer, Palmyra, NJ (US)

Correspondence Address: Charles G. Bauer, 200 Cinnaminson Ave., Palmyra, NJ, 08065, US

(21) Appl. No.: 12/006,578

(22) Filed: Jan. 4, 2008

(51) Int. Cl. B01D 47/00; B01F 3/04

(52) U.S. Cl. 261/66; 261/116

(57) ABSTRACT

A one piece spray cylinder/nozzle, with integrally machined nozzles, for use on a high pressure and temperature, probe style, variable nozzle, gas and steam coolers. The nozzle holes can be made by deep drilling techniques such as laser, gun drilling and others methods that produce a hole, with a diameter to depth ratio of less than 1:3. No separately machined nozzles are used. On the outlet end of the nozzle (on the outside of the cylinder only), there are surface machining treatments to produce small, controllable liquid droplets that vaporize quickly into the gas or vapor stream. The spray cylinder bore can be coated, lined or hard faced to resist the ware of the piston rings sliding in it without adding stresses to the spray cylinder body at braze and weld joints. The flow and patterns and valve characteristics can be modified.

### BACKGROUND OF INVENTION AND RELATED ARTS STATEMENT

1. Field of Invention

The present invention relates to the field of liquid injection into a vapor or gas stream pipe for the purpose of cooling the stream. More particularly, to control valves for steam and gas coolers of the insertion probe style, with their variable opening nozzle spray cylinder that have mounted on them pneumatic, electric or hydraulic actuator and positioner.

2. Background of Invention

Various designs have been produced similar to the Brand U.S. Pat. No. 4,130,611 using multiple separate nozzles mounted in a pre-machined cylinder by brazing or seal welding. They had to be made this way for two reasons: To shorten the length of the small diameter feeder ports to below a diameter to length 1:3 ratio. This ratio is the standard drilling capability. A hole with a length above the 1:3 ratio is considered a “deep hole” and causes increased cost. The nozzles were of the centripetal type, using a pre-chamber around the nozzle to acquire a rotating flow or an angle drilled plate, Johnson U.S. Pat. No. 4,442,047, before the nozzle both of which produced a hollow cone shaped spray pattern.

The multiple piece cylinder/nozzle assembly has many draw backs: In high temperature applications above 900° F. the corners of the annular flow chamber are high thermal stress concentration points where cracking of the cylinder begins causing cylinder failure. The brazing in of the nozzles limits the surface treatments available to harden the internal cylinder bore, where the piston rings slide. Seal welding in the nozzles is expensive and forms high stress points where cracking can begin at high operating temperatures. The cone spray pattern at the top of the spray cylinder can throw liquid against the hot vapor pipes causing poor mixing, loss of temperature control and damage to the pipe. As the nozzles get larger they must be placed farther apart around the cylinder and the cone spray pattern goes perpendicular to the vapor flow and hits the wall of the pipe or the other spray cones causing poor mixing and loss of temperature control. The multi part nozzle/cylinder assembly is costly due to the machining, brazing or welding and post assembly heat treating required. A minimum number of feeder ports must be opened to the liquid flow before the cone pattern is achieved making it useable and controllable.

### DETAILED DESCRIPTION OF THE PREFERRED EMBODIMENT(S) OF THE INVENTION

In light of the aforementioned problems, it is the object of my invention to make a one piece spray cylinder with the nozzles machined directly into it using deep hole drilling technology (below 1:3 diameter to length ratio) and with or without face modifications on the nozzles' outlet side only to form the spray patterning to reduce the liquid droplets to a useable and controllable size.

The nozzle holes can be made using gun drilling, twist drill or any other method that produces a smooth straight hole into the cylinder. The inside of the cylinder is honed smooth for the piston rings to slide in. The plurality of the holes and the holes' diameter is determined by the quantity of liquid flow required and the opening characteristics desired of the valve. The opening characteristics can be, but not limited to, equal percentage, linier, quick opening and others. The first nozzle is located to give a dead ban, allowing the seat to open before the piston ring allows the liquid to enter the first nozzle hole. This protects the seat from erosion at high differential pressures between the liquid & vapor or gas. As the piston moves further downward, the piston ring clears the nozzle holes, the liquid flows into the nozzles & turbulence is removed as the liquid moves toward the outside edge of the spray cylinder.

The nozzle dressing or machining on the outside of the spray cylinder only, produces a plurality of droplet reductions including but not limited to:

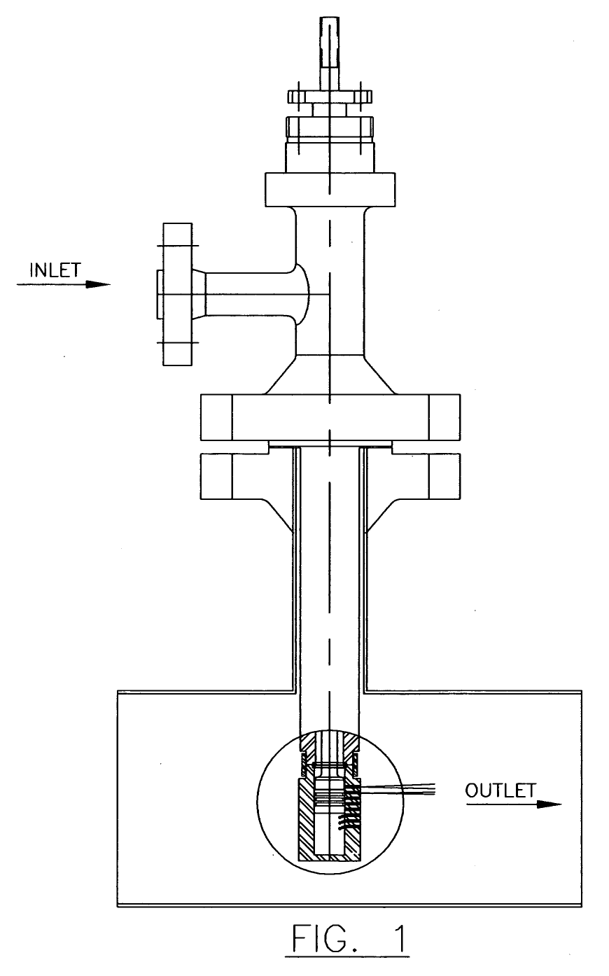

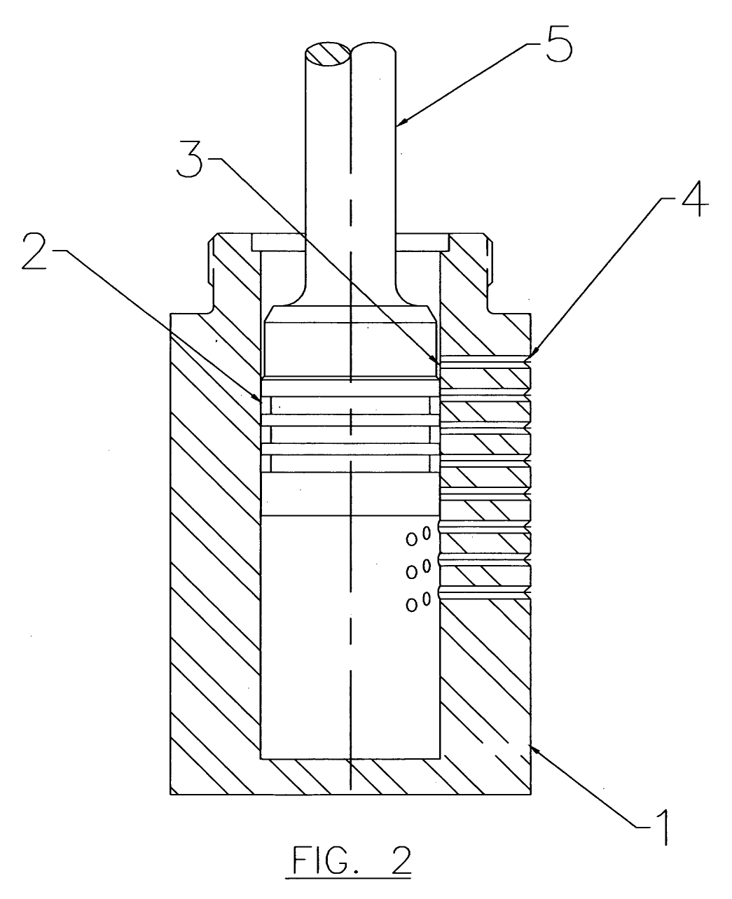

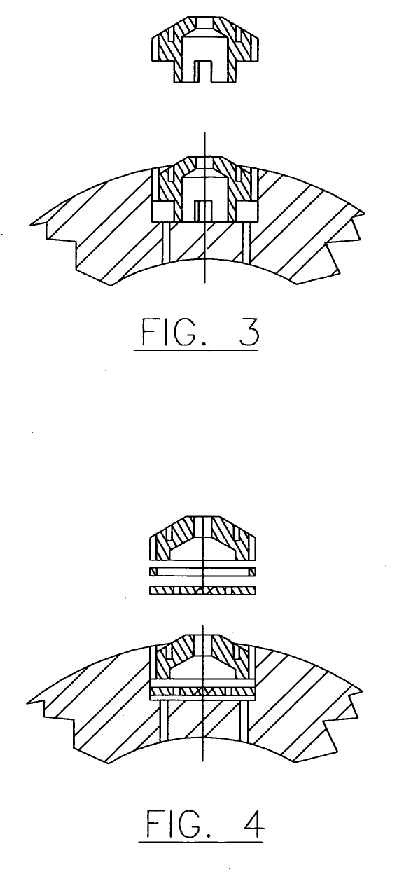

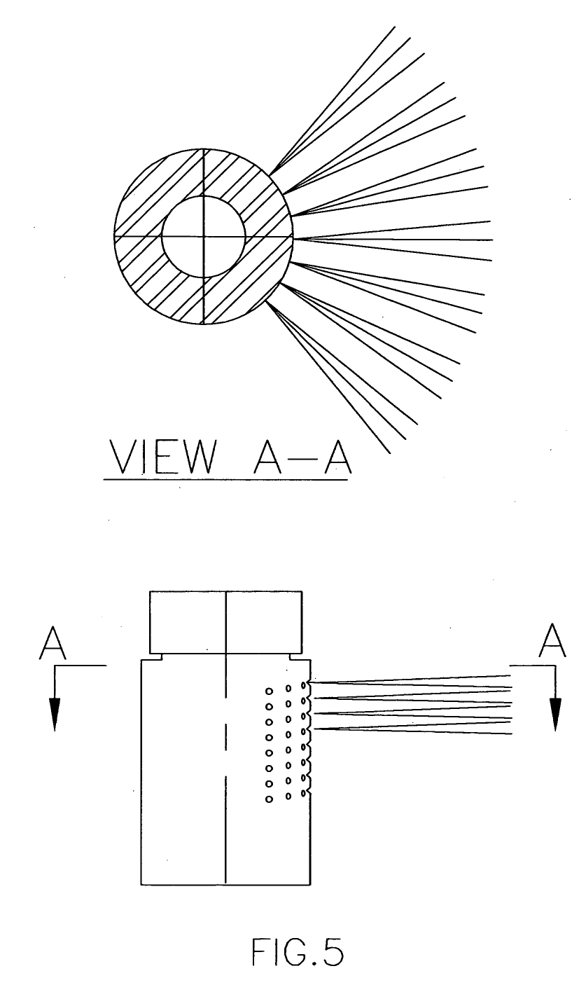

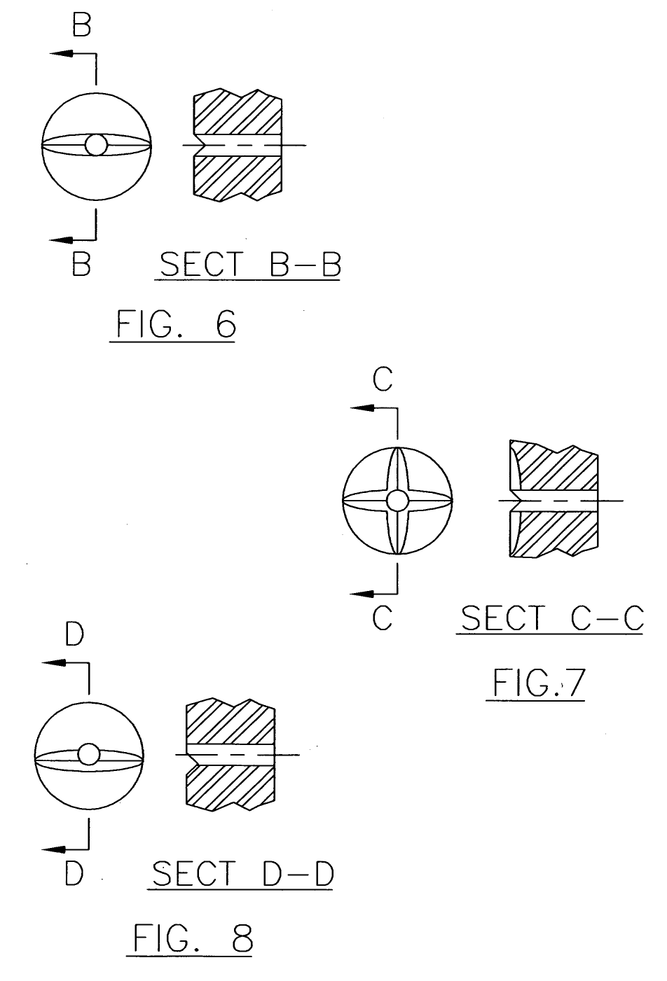

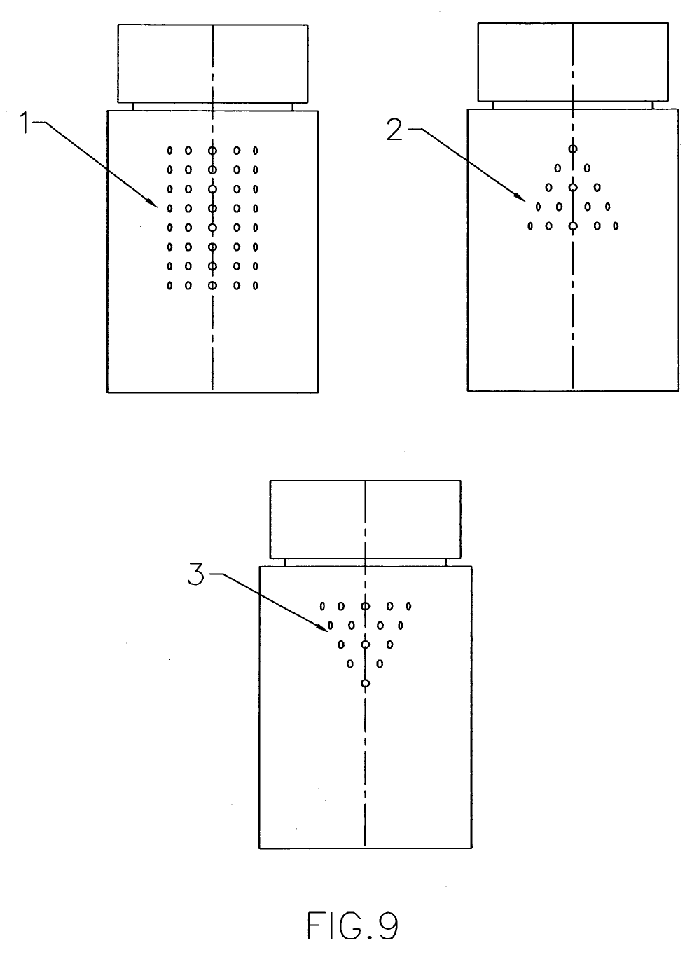

Straight hole 90 Deg. to cylinder—produces a 7 Deg. full cone spray pattern.
A “V” slot across the center of the nozzle hole—produces a thin fan 1 Deg. by 15-20 Deg. spray pattern FIG. 6.
Two “V” Slots across the center (“X” pattern) of the nozzle—produces a crossed fan spread spray pattern FIG. 7.
A “V” slot across the nozzle hole but not centered on it—produces a bowed fan spread spray pattern FIG. 8.
The maximum diameter of the nozzle holes is only limited by the ability of the piston rings to transverse the inside feeder end of the hole.

While in the forgoing, a preferred embodiment of the invention has been described, it should be obvious to one skilled in the art that various changes and modifications can be made without departing from the spirit and scope of the invention as recited in the appended claims.

I claim:

1- An actuated and/or automated probe type liquid injection valve of the Brand type that has a stem/disc with piston rings to meter the opening of ports, the improvement comprising of a detachable one piece spray cylinder with a plurality of nozzles.

2- The spray cylinder of claim 1, has nozzle holes that transverse the side of the spray cylinder being made by a deep hole (below 1:3 diameter to length ratio).

3- The spray cylinder of claim 1, has nozzle holes that produce spray patterning with only machining treatments external of the spray cylinder to the nozzle holes where liquid exits the outside of the spray cylinder at around 90 deg. from the cylinder's center line and produces small controllable droplets.

4- The spray cylinder of claim 1, has plurality of nozzle holes producing spray patterning located on a spray cylinder to providing the valve with a multitude of flow opening characteristics, of but not limited to linier, equal-percentage, and others.

5- The spray cylinder of claim 1, that can be heat treated, case harden or lined to resist wear for the piston rings to sliding against its bore.

6- The spray cylinder of claim 1, that takes a full pressure differential of the liquid/vapor across the piston ring to nozzle interface.
